(19) United States
(12) Patent Application Publication
(10) Pub. No.: US 2011/0093954 A1
(43) Pub. Date: Apr. 21, 2011

(54) APPARATUS AND METHOD FOR REMOTELY DIAGNOSING SECURITY VULNERABILITIES

(75) Inventors: Hyung Kyu LEE, Daejeon (KR); Jong-Wook HAN, Daejeon (KR); Hyun sook CHO, Daejeon (KR)

(73) Assignee: Electronics and Telecommunications Research Institute, Daejeon (KR)

(21) Appl. No.: 12/638,690

(22) Filed: Dec. 15, 2009

(30) Foreign Application Priority Data
Oct. 19, 2009 (KR) 10-2009-0099167

(51) Int. Cl. G06F 11/00

(52) U.S. Cl. 726/25; 709/224; 714/37

(57) ABSTRACT

An apparatus for remotely diagnosing security vulnerabilities, includes a vulnerability analysis unit for obtaining service information by searching a target device of a specific network and a port of the target device, searching a profile DB for principal characteristic information of the acquired service information, determining a query key type based on the retrieved principal characteristic information to acquire a vulnerability diagnosis list present in the principal characteristic information from a vulnerability list management DB; and an attack agent for diagnosing a vulnerability of the principal characteristic information on the vulnerability diagnosis list based on preset characteristic information. Further, the apparatus includes a result analysis unit for reporting a result of the diagnosis of the vulnerability of the principal characteristic information; and a GUI management unit for performing interfacing of the result of the diagnosis of the vulnerability of the principal characteristic information to a vulnerability diagnosis tool.

### CROSS-REFERENCE TO RELATED APPLICATIONS

The present invention claims priority of Korean Patent Application No. 10-2009-0099167, filed on Oct. 19, 2009, which is incorporated herein by reference.

### FIELD OF THE INVENTION

The present invention relates to an apparatus and method for remotely diagnosing security vulnerabilities; and, more particularly, to an apparatus and method which is capable of acquiring information such as the version of a service program, from the service port of a device or a system, determining the type of principal characteristic information, acquiring a vulnerability list using the type of principal characteristic information as a search key, performing vulnerability diagnosis, and diagnosing the device by making a query for a common vulnerability list, thereby giving a report to a remote vulnerability diagnosis tool.

### BACKGROUND OF THE INVENTION

With the development of the information industry and technology, various types of network systems suitable for different user environments have been developed. That is, the society of the present day has developed such that in regions close to humans, various devices and systems such as home network devices and intelligent network robots, are connected to each other over networks to provide various types of services.

Since many security threats and requirements arise in spite of the above-described development of the network environment and it is difficult for general persons or small-sized businesses lacking experience or resources regarding security to solve security problems by themselves, it is necessary to request the diagnosis of security vulnerabilities.

Meanwhile, most conventional security vulnerability diagnosis tools are installed and executed in and on systems, and are used to analyze and detect security threats present in the systems. Security vulnerability diagnosis tools which are developed to be remotely executed are developed by professional security service providers, e.g., a Managed Service Security Provider (MSSP) by themselves, and are used only to diagnose specific devices or systems or to diagnose the common security vulnerabilities of various systems.

However, it is difficult for the above-described conventional diagnosis tools for performing security vulnerability analysis, which were developed to be remotely executed, to diagnose the security vulnerabilities of devices or systems in various environments, i.e., network environments in which heterogeneous devices such as intelligent network robots and home network devices are present.

That is, when each of the conventional vulnerability diagnosis tools diagnoses a system regardless of the characteristics of a network service, operating system or system, it is operated in such a way as to check the entire vulnerability list of all systems and operating systems diagnosed by the diagnosis tools and to respond to this.

For example, when two systems, i.e., first and second systems having different operating systems exist, although the first and second systems provide the same types of network services, it is not necessary to search, in the second system, a service present only in the first system because the type and version of a network service program provided by the first system are different from those of a network service program provided by the second system. In other words, since the first system uses a unique type and version of program suitable for itself and the second system uses another type and version of a program, a conventional vulnerability diagnosis tool is operated without differentiation on the assumption that all services and all types of system programs (daemons) are present. Accordingly, the conventional diagnosis tools are disadvantageous in that the rate of erroneous diagnosis is high, unnecessary diagnosis is performed and many diagnostic tools are required due to the characteristics, thereby causing a lot of overhead regarding diagnosing time and cost.

### SUMMARY OF THE INVENTION

In view of the above, the present invention provides an apparatus and method which is capable of, in a network environment in which various heterogeneous devices such as intelligent network robots and home network devices are present, acquiring information such as the version of a service program from the service port of a device or a system, determining the type of principal characteristic information, acquiring a vulnerability list using the type of principal characteristic information as a search key, performing vulnerability diagnosis, diagnosing the device by making a query for a common vulnerability list, thereby giving a report to a remote vulnerability diagnosis tool.

In accordance with a first aspect of the present invention, there is provided an apparatus for remotely diagnosing security vulnerabilities, including: a vulnerability analysis unit for obtaining service information by searching a target device of a specific network and a port of the target device, searching a profile DataBase (DB) for principal characteristic information of the acquired service information, determining a query key type based on the retrieved principal characteristic information to acquire a vulnerability diagnosis list present in the principal characteristic information from a vulnerability list management DB using the determined query key type as a search key; an attack agent for diagnosing a vulnerability of the principal characteristic information on the vulnerability diagnosis list present in the principal characteristic information based on preset characteristic information; a result analysis unit for reporting a result of the diagnosis of the vulnerability of the principal characteristic information; and a Graphical User Interface (GUI) management unit for performing interfacing of the result of the diagnosis of the vulnerability of the principal characteristic information to a vulnerability diagnosis tool.

In accordance with a second aspect of the present invention, there is provided a method of remotely diagnosing security vulnerabilities, including: obtaining service information by searching a target device of a specific network and a port of the target device; if principal characteristic information of the acquired service information has been retrieved from a profile DB, determining a query key type based on the retrieved principal characteristic information; acquiring a vulnerability diagnosis list present in the principal characteristic information from a vulnerability list management DB using the determined query key type as a search key; diagnosing a vulnerability of the principal characteristic information on a vulnerability diagnosis list present in the principal characteristic information based on preset characteristic information; and reporting a result of the diagnosis of the vulnerability of the principal characteristic information to a vulnerability diagnosis tool.

In accordance with an embodiment of the present invention, it is possible to, in a network environment in which various heterogeneous devices such as an intelligent network robot and a home network device are present, acquire information such as the version of a service program from the service port of a device or a system, determine the type of principal characteristic information, acquire a vulnerability list using the type of principal characteristic information as a search key, perform vulnerability diagnosis, diagnose the device by making a query for a common vulnerability list and give a report to a remote vulnerability diagnosis tool, thereby solving the existing problem in which it is difficult to diagnose the security vulnerability of a device or a system.

Furthermore, it is possible to reliably analyze vulnerabilities because detailed information about the vulnerability of a corresponding device or system can be acquired, provide the convenience of use, rapidity and accuracy to security service providers or general home network users, and, in particular, be able to improve the reliability of a network environment in which various devices are present, thereby contributing to the activation of the use of service.

### BRIEF DESCRIPTION OF THE DRAWINGS

The objects and features of the present invention will become apparent from the following description of embodiments given in conjunction with the accompanying drawings, in which:

FIG. 1 is a block diagram showing the construction of an apparatus for remotely diagnosing security vulnerabilities in accordance with an embodiment of the present invention; and

FIGS. 2A and 2B are flow charts sequentially showing a method of remotely diagnosing security vulnerabilities n accordance with the embodiment of the present invention.

### DETAILED DESCRIPTION OF THE EMBODIMENTS

Embodiments of the present invention will be described in detail with reference to the accompanying drawings which form a part hereof.

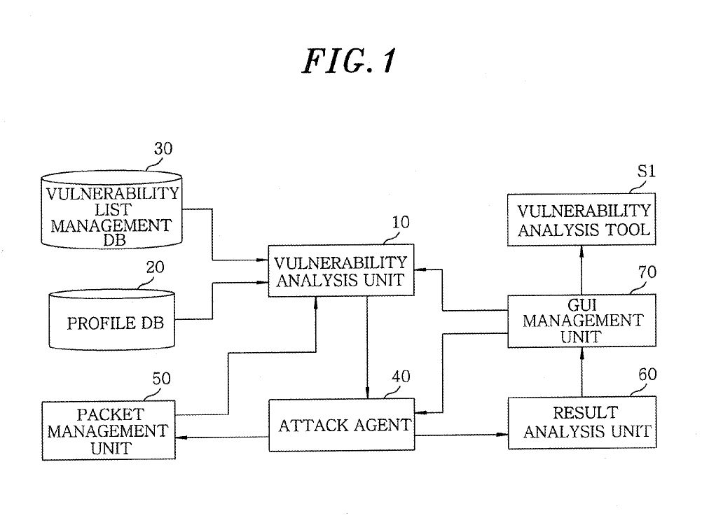

FIG. 1 is a block diagram showing the construction of an apparatus for remotely diagnosing security vulnerabilities in accordance with an embodiment of the present invention. The apparatus for remotely diagnosing security vulnerabilities includes a vulnerability analysis unit 10, a profile DataBase (DB) 20, a vulnerability list management DB 30, an attack agent 40, a packet management unit 50, a result analysis unit 60, and a Graphical User Interface (GUI) management unit 70.

The vulnerability analysis unit 10 is a block for detecting an operating system, generating a pattern, and analyzing a network and a device or a system. The vulnerability analysis unit 10 searches one or more devices within a preset, selected, specific network domain requiring vulnerability analysis and the service port of each found target device in response to a request for the searching of the target devices within the specific network domain and the service port of the target device, which is input from a vulnerability diagnosis tool S1 through the GUI management unit 70.

Here, the vulnerability diagnosis tool S1 is a block for performing the risk analysis of a network, applied risk analysis and the risk analysis of a device or a system and for serving as a management tool. The vulnerability diagnosis tool S1 probes the presence of a device or a system within a specific network environment (e.g., a network environment in which various heterogeneous devices such as an intelligent network robot and a home network device are present) using an Address Resolution Protocol (ARP) packet, and prepares a target device list for vulnerability analysis or performs selection on the basis of provided basic information so that devices requiring analysis can be previously set.

Furthermore, the vulnerability analysis unit 10 determines whether information, such as the version of a service program, has been acquired from a found target device in a specific network domain and the service port of the target device, and if information such as the version of a service program has not been acquired, acquires a device or system-independent overall vulnerability diagnosis list by querying the vulnerability list management DB 30 to provide the acquired overall vulnerability diagnosis list to the attack agent 40.

Furthermore, the vulnerability analysis unit 10 determines whether information such as the version of a service program has been acquired from the found target device in a specific network domain and the service port of the target device, and, if information such as the version of a service program has been acquired from the service port of the target device, searches the profile DB 20 for the principal characteristic information of the acquired information. If this search is not successful, the vulnerability analysis unit 10 acquires a device or system-independent overall vulnerability diagnosis list by querying the vulnerability list management DB 30 to provide the acquired overall vulnerability diagnosis list to the attack agent 40.

Furthermore, the vulnerability analysis unit 10 searches the profile DB 20 for the principal characteristic information of the acquired information (e.g., one of an operating system, the version of the operating system, an installed daemon program and a version list), and if the search is successful, determines the type of query key on the basis of the principal characteristic information, acquires a vulnerability diagnosis list present in the corresponding principal characteristic information by querying the vulnerability list management DB 30 using the determined type of query key as a search key, and provides the vulnerability diagnosis list present in the acquired corresponding principal characteristic information to the attack agent 40.

For example, referring to Table 1, when the fact that a web server running on a system to be diagnosed is apache 1.2.2 is found by initial probing, the vulnerability analysis unit 10 can estimate that the operating system of the corresponding system is Solaris and the version thereof is 5.8 by searching the profile DB 20.

Furthermore, in response to a result indicative of the presence of vulnerability input from the packet management unit 50, the vulnerability analysis unit 10 acquires a common vulnerability diagnosis list by querying the vulnerability list management DB 30, and provides the acquired common vulnerability diagnosis list to the attack agent 40.

The profile DB 20 is a block for storing the profiles of a device or a system and the like. As shown in Table 1, such a profile is configured to include principal characteristic information such as an operating system, the version of the operating system, an installed daemon program and a version list.

TABLE 1

| | |
|---|---|
| OS: Windows | OS: Redhat Linux |
| Version: 2000 | Version: 9.0 |
| Webserver: IIS 5.0 | WebServer: apache 2.2 |
| | FTP Server: wuftpd 2.4 |
| | Samba Server: smbd 2.0 |
| | Mail Server: sendmail 8.6 |
| OS: Windows | OS: Solaris |
| Version: XP | Version: 5.8 |
| WebServer: IIS 5.1 | WebServer: apache 1.2.2 |
| | FTP Server: proftpd 2.1 |
| | Mail Server: sendmail 8.4 |
| OS: Windows | OS: FreeBSD |
| Version: 2003 | Version: 6 |
| WebServer: IIS 6.0 | WebServer: apache 1.2.4 |
| | FTP Server: proftpd 2.0 |
| | Mail Server: sendmail 8.0 |
| OS: Debian Linux | |
| Version: 3.0r12 | |
| WebServer: Apache 2.0 | |
| FTP Server: wuftpd 2.0 | |
| Samba Server: smbd 1.2 | |
| Mail Server: sendmail 8.4 | |

The vulnerability list management DB 30 is constructed by removing redundancy from data, retrieved using the principal characteristic information as a query key-type search key with respect to the target device or system determined by the vulnerability analysis unit 10, in such a way as to perform operation on the retrieved data on the basis of dependency and independency and by creating and storing the vulnerability diagnosis list present in the corresponding principal characteristic information on the basis of the correlation between respective query key types.

The attack agent 40 is a block for diagnosing vulnerability defined in a vulnerability list using a network attack module and a device or system attack module. In response to a request for diagnosis from the vulnerability diagnosis tool S1, the attack agent 40 diagnoses an overall vulnerability on the overall vulnerability diagnosis list, input from the vulnerability analysis unit 10, on the basis of preset characteristic information, and, as a result of the diagnosis, if the overall vulnerability is determined not to be present, provides a result indicative of the absence of the overall vulnerability to the result analysis unit 60. Meanwhile, the attack agent 40 diagnoses an overall vulnerability on an overall vulnerability diagnosis list, input from the vulnerability analysis unit 10, on the basis of preset characteristic information, and, as a result of the diagnosis, if the overall vulnerability is determined to be present, provides a result indicative of the presence of the overall vulnerability to the packet management unit 50.

Furthermore, the attack agent 40 diagnoses the vulnerability of principal characteristic information on a vulnerability diagnosis list present in corresponding principal characteristic information input from the vulnerability analysis unit 10 on the basis of preset characteristic information, and, if, as a result of the diagnosis, the vulnerability of principal characteristic information is determined not to be present, provides a result indicative of the absence of the vulnerability of the principal characteristic information to the result analysis unit 60. On the other hand, the attack agent 40 diagnoses the vulnerability of the principal characteristic information on a vulnerability diagnosis list present in the corresponding principal characteristic information, input from the vulnerability analysis unit 10 on the basis of preset characteristic information, and, if, as a result of the diagnosis, the vulnerability of the principal characteristic information is determined to be present, provides a result indicative of the presence of the vulnerability of the principal characteristic information to the packet management unit 50.

Furthermore, the attack agent 40 diagnoses a common vulnerability on a common vulnerability diagnosis list, input from the vulnerability analysis unit 10, on the basis of preset characteristic information, and if the common vulnerability is determined not to be present, provides a result indicative of the absence of the common vulnerability to the result analysis unit 60. On the other hand, the attack agent 40 diagnoses a common vulnerability on a common vulnerability diagnosis list input from the vulnerability analysis unit 10, on the basis of preset characteristic information, and if the common vulnerability is determined to be present, provides a result indicative of the presence of the common vulnerability to the result analysis unit 60.

The packet management unit 50 is a block for managing attack and probe packets. The packet management unit 50 manages whether a packet regarding a result indicative of the presence of vulnerability input from the attack agent 40 is an attack packet or a probe packet, and provides the result indicative of the presence of the vulnerability to the vulnerability analysis unit 10.

The result analysis unit 60 is a block for reporting a diagnostic result. The result analysis unit 60 provides a result indicative of the presence or absence of vulnerability, input from the attack agent 40, to the GUI management unit 70.

The GUI management unit 70 is a block for performing interfacing such as diagnosis result reporting to the vulnerability diagnosis tool S1, device or system setting, and attack pattern definition. The GUI management unit 70 performs interfacing to request the vulnerability diagnosis the vulnerability analysis unit 10 or the attack agent 40 to perform the searching of or make diagnosis on a target device in a preset, selected specific network domain requiring vulnerability analysis and the service port of the target device, which is input from the vulnerability analysis tool S1, and performs interfacing to report a result indicative of the absence or presence of vulnerability, input from the result analysis unit 60 to the vulnerability diagnosis tool S1.

Accordingly, the present invention is configured to, in a network environment in which various heterogeneous devices, such as an intelligent network robot and a home network device, are present, acquire information such as the version of a service program from the service port of a device or a system, determine the type of principal characteristic information, acquire a vulnerability list using the type of principal characteristic information as a search key, perform vulnerability diagnosis, diagnose the device by making a query for a common vulnerability list, and make a report to a remote vulnerability diagnosis tool, so that it can solve the existing problem in which it is difficult to diagnose the security vulnerability of a device or a system.

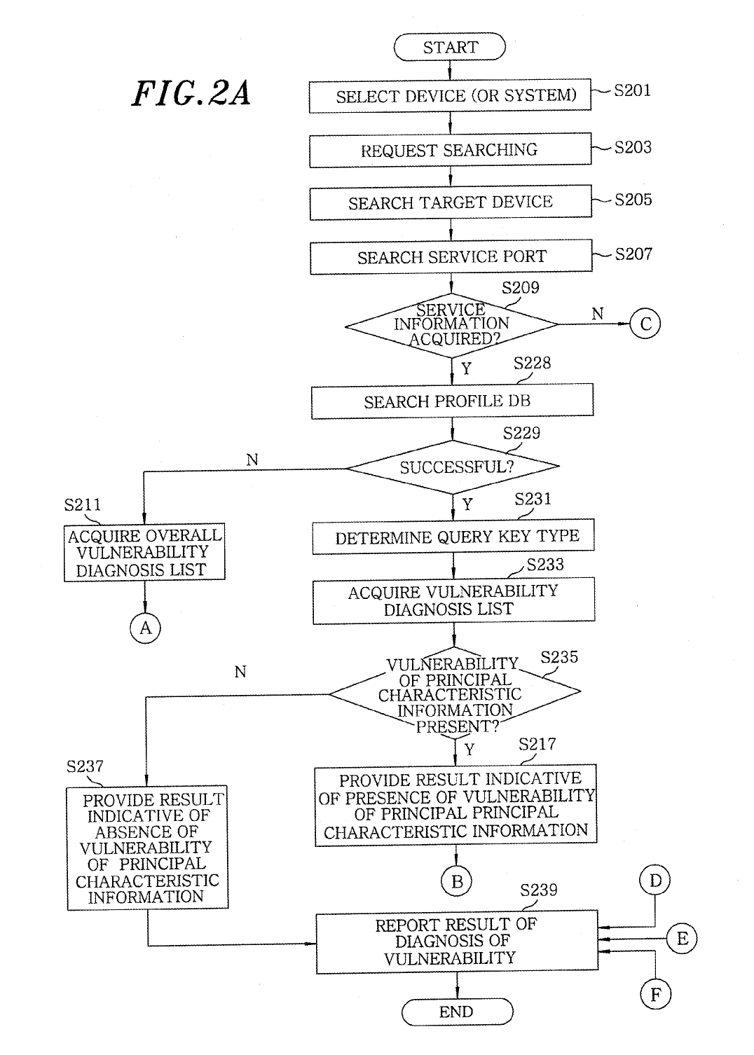

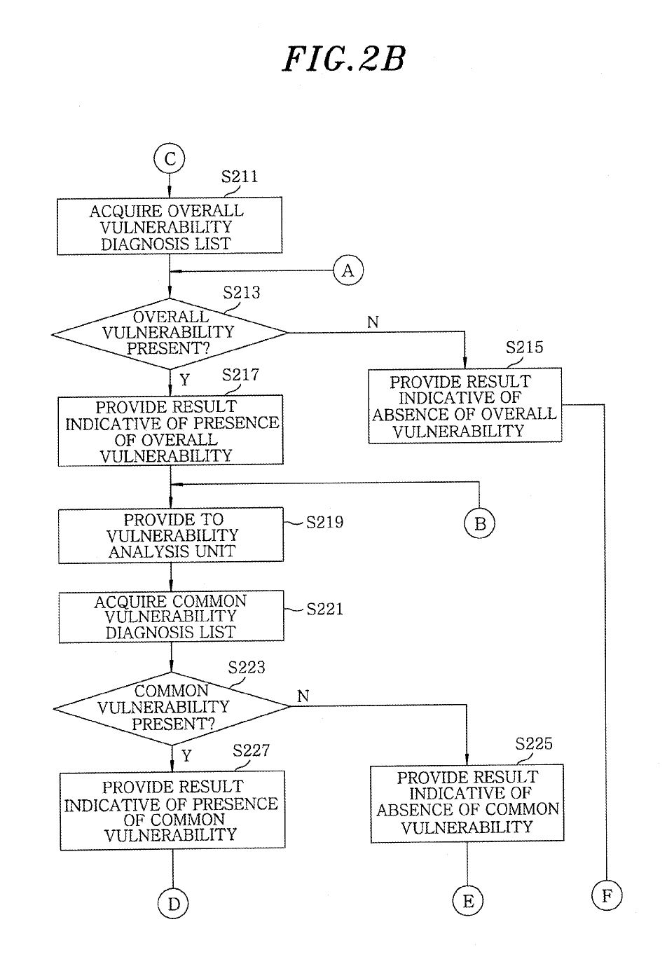

FIGS. 2A and 2B are flow charts sequentially showing a method of remotely diagnosing security vulnerabilities in accordance with an embodiment of the present invention.

First, the vulnerability diagnosis tool S1 probes whether one or more devices or systems are present within a specific network domain (e.g., a network environment in which various heterogeneous devices, such as intelligent network robots and home network devices, are present) with ARP packets, and prepares a list of target devices for vulnerability analysis or selects one or more devices requiring analysis on the basis of provided basic information in step S201.

After the devices have been selected, the vulnerability diagnosis tool S1 remotely requests the searching of one or more target devices in a selected specific network domain and the service port of a found target device from the vulnerability analysis unit 10 through the GUI management unit 70 in step S203.

The vulnerability analysis unit 10 searches one or more target devices in a specific network domain in step S205 and the service port of a found target device in step S207 in response to the request for searching of the target devices within a preset, selected specific network domain requiring vulnerability analysis and the service port of the found target device, which is input from the vulnerability diagnosis tool S1 through the GUI management unit 70.

Thereafter, the vulnerability analysis unit 10 determines whether information such as the version of a service program, has been acquired from a found target device within a specific network domain and the service port of the target device in step a S209.

As a result of the determination in step S209, if information such as the version of a service program is determined not to have been acquired, a device or system-independent overall vulnerability diagnosis list is acquired by querying the vulnerability list management DB 30 in step S211 and the acquired overall vulnerability diagnosis list is provided to the attack agent 40.

The attack agent 40 diagnoses an overall vulnerability on the overall vulnerability diagnosis list, input from the vulnerability analysis unit 10, on the basis of preset characteristic information in step S213.

As a result of the diagnosis in step S213, if the overall vulnerability is determined not to be present, a result indicative of the absence of overall vulnerability is provided to the result analysis unit 60 in step S215. On the other hand, as a result of the diagnosis in step S213, if the overall vulnerability is determined to be present, a result indicative of the presence of overall vulnerability is provided to the packet management unit 50 in step S217.

The packet management unit 50 manages whether a packet regarding a result indicative of the presence of vulnerability input from the attack agent 40 is an attack packet or a probe packet and provides the result indicative of the presence of vulnerability to the vulnerability analysis unit 10 in step S219.

In response to the results of the diagnosis of vulnerability input from the packet management unit 50, the vulnerability analysis unit 10 acquires a common vulnerability diagnosis list by querying the vulnerability list management DB 30 in step S221, and provides the acquired common vulnerability diagnosis list to the attack agent 40.

The attack agent 40 diagnoses a common vulnerability on the common vulnerability diagnosis list input from the vulnerability analysis unit 10 on the basis of preset characteristic information in step S223.

As a result of the diagnosis in step S223, if the common vulnerability is determined not to be present, a result indicative of the absence of common vulnerability is provided to the result analysis unit 60 in step S225. On the other hand, as a result of the diagnosis in step S223, if the common vulnerability is determined to be present, a result indicative of the presence of common vulnerability is provided to the result analysis unit 60 in step S227.

As a result of the determination in step S209, if information such as the version of a service program is determined to have been acquired, the profile DB 20 constructed as shown in Table 1 is searched for principal characteristic information regarding the acquired information in step S228, and then whether the searches have been successful is checked in step S229.

As a result of the checking in step S229, if the searches are determined not to be successful, a device or system-independent overall vulnerability diagnosis list is acquired by querying the vulnerability list management DB 30 in step S211, the acquired overall vulnerability diagnosis list is provided to the attack agent 40, and then steps S213 to S227 are performed.

As a result of the checking in step S229, if the searches are determined to have been successful, a query key type is determined on the basis of principal characteristic information in step S231, a vulnerability diagnosis list present in corresponding principal characteristic information is acquired by querying the vulnerability list management DB 30 using the determined type of query key as a search key in step S233, and the acquired vulnerability diagnosis list present in the corresponding principal characteristic information is provided to the attack agent 40.

The attack agent 40 diagnoses the vulnerability of the principal characteristic information on the vulnerability diagnosis list present in the corresponding principal characteristic information, which is input from the vulnerability analysis unit 10, on the basis of preset characteristic information in step S235.

As a result of the diagnosis in step S235, if the vulnerability of the principal characteristic information is determined not to be present, a result indicative of the absence of the vulnerability of the principal characteristic information is provided to the result analysis unit 60 in step S237. Meanwhile, as a result of the diagnosis, if the vulnerability of the principal characteristic information is determined to be present, a result indicative of the presence of the vulnerability of the principal characteristic information is provided to the packet management unit 50 in step S217 and then steps 219 to 227 are performed.

Finally, the result analysis unit 60 reports a result indicative of the absence of vulnerability or the presence of vulnerability, input from the attack agent 40, to the vulnerability diagnosis tool S1 through the GUI management unit 70 in step S239.

Meanwhile, the method of remotely diagnosing security vulnerabilities in accordance with an embodiment of the present invention, which presents the above-described various embodiments, may be implemented using code which can be stored on a computer-readable recording medium. A computer-readable storage medium may be a type of recording device on which has been stored data which can be read by a computer system. Examples of such a computer-readable medium are Read-Only Memory (ROM), Random Access Memory (RAM), Compact Disk (CD)-ROM, a magnetic tape, a floppy disk, an optical data storage device and carrier waves (e.g., in the case of transmission over the Internet). Computer-executable code or a computer-executable program may be distributed and executed among the computer systems connected by a network to perform the functions of the present invention in a distributed manner.

While the invention has been shown and described with respect to the embodiments, it will be understood by those skilled in the art that various changes and modifications may be made without departing from the scope of the invention as defined in the following claims.

What is claimed is:

1. An apparatus for remotely diagnosing security vulnerabilities, comprising:
a vulnerability analysis unit for obtaining service information by searching a target device of a specific network and a port of the target device, searching a profile DataBase (DB) for principal characteristic information of the acquired service information, determining a query key type based on the retrieved principal characteristic information to acquire a vulnerability diagnosis list present in the principal characteristic information from a vulnerability list management DB using the determined query key type as a search key;
an attack agent for diagnosing a vulnerability of the principal characteristic information on the vulnerability diagnosis list present in the principal characteristic information based on preset characteristic information;
a result analysis unit for reporting a result of the diagnosis of the vulnerability of the principal characteristic information; and
a Graphical User Interface (GUI) management unit for performing interfacing of the result of the diagnosis of the vulnerability of the principal characteristic information to a vulnerability diagnosis tool.

2. The apparatus of claim 1, wherein the vulnerability analysis unit acquires a common vulnerability diagnosis list from the vulnerability list management DB if the vulnerability of the principal characteristic information is diagnosed as being present by the attack agent.

3. The apparatus of claim 2, wherein the attack agent diagnoses a common vulnerability on the common vulnerability diagnosis list based on preset characteristic information, provides a result indicative of absence of the common vulnerability to the result analysis unit if the common vulnerability is not present, and provides a result indicative of presence of the common vulnerability to the result analysis unit if the common vulnerability is present.

4. The apparatus of claim 3, wherein the result analysis unit reports a result indicative of the absence of the common vulnerability and a result indicative of the presence of the common vulnerability to the vulnerability diagnosis tool through the GUI management unit.

5. The apparatus of claim 1, wherein the vulnerability analysis unit searches a port of the target device, and acquires an overall vulnerability diagnosis list from the vulnerability list management DB if the service information has not been acquired.

6. The apparatus of claim 5, wherein the attack agent diagnoses an overall vulnerability on the overall vulnerability diagnosis list based on preset characteristic information, provides a result indicative of absence of the overall vulnerability to the result analysis unit if the overall vulnerability is not present, and provides a result indicative of presence of the overall vulnerability to the packet management unit if the overall vulnerability is present.

7. The apparatus of claim 6, wherein the result analysis unit reports the result indicative of the absence of the overall vulnerability to the vulnerability diagnosis tool through the GUI management unit.

8. The apparatus of claim 1, wherein the vulnerability analysis unit acquires an overall vulnerability diagnosis list from the vulnerability list management DB if principal characteristic information of the service information has not been retrieved from the profile DB.

9. The apparatus of claim 1, wherein the vulnerability list management DB is constructed by removing redundancy from data retrieved using the principal characteristic information as a query key-type search key with respect to the target device, in such a way as to perform operation on the retrieved data based on dependency and independency and by creating and storing a vulnerability diagnosis list present in the corresponding principal characteristic information based on correlation between respective query key types.

10. The apparatus of claim 1, wherein the principal characteristic information is any one of an operating system, a version of the operating system, a daemon program and a version list.

11. A method of remotely diagnosing security vulnerabilities, comprising:
obtaining service information by searching a target device of a specific network and a port of the target device;
if principal characteristic information of the acquired service information has been retrieved from a profile DB, determining a query key type based on the retrieved principal characteristic information;
acquiring a vulnerability diagnosis list present in the principal characteristic information from a vulnerability list management DB using the determined query key type as a search key;
diagnosing a vulnerability of the principal characteristic information on a vulnerability diagnosis list present in the principal characteristic information based on preset characteristic information; and
reporting a result of the diagnosis of the vulnerability of the principal characteristic information to a vulnerability diagnosis tool.

12. The method of claim 11, wherein the acquiring a vulnerability diagnosis list comprises acquiring a common vulnerability diagnosis list from the vulnerability list management DB if vulnerability of the principal characteristic information is diagnosed as being present by the attack agent.

13. The method of claim 12, wherein the diagnosing a vulnerability comprises diagnosing a common vulnerability on the common vulnerability diagnosis list based on preset characteristic information, providing a result indicative of absence of the common vulnerability to the result analysis unit if the common vulnerability is not present, and providing a result indicative of presence of the common vulnerability to the result analysis unit if the common vulnerability is present.

14. The method of claim 13, wherein the reporting a result of the diagnosis comprises reporting a result indicative of the absence of the common vulnerability and a result indicative of the presence of the common vulnerability to the vulnerability diagnosis tool through the GUI management unit.

15. The method of claim 11, wherein the vulnerability analysis unit searches a port of the target device, and acquires an overall vulnerability diagnosis list from the vulnerability list management DB if the service information has not been acquired.

16. The method of claim 15, wherein the diagnosing vulnerability comprises diagnosing an overall vulnerability on the overall vulnerability diagnosis list based on preset characteristic information, providing a result indicative of absence of the overall vulnerability to the result analysis unit if the overall vulnerability is not present, and providing a result indicative of presence of the overall vulnerability to the packet management unit if the overall vulnerability is present.

17. The method of claim 16, wherein the reporting a result of the diagnosis comprises reporting the result indicative of the absence of the overall vulnerability to the vulnerability diagnosis tool through the GUI management unit.

18. The method of claim 11, wherein the acquiring a vulnerability diagnosis list comprises acquiring an overall vulnerability diagnosis list from the vulnerability list management DB if principal characteristic information of the service information has not been retrieved from the profile DB.

19. The method of claim 11, wherein the vulnerability list management DB is constructed by removing redundancy from data, retrieved using the principal characteristic information as a query key-type search key with respect to the target device, in such a way as to perform operation on the retrieved data based on dependency and independency and by creating and storing a vulnerability diagnosis list preset in the corresponding principal characteristic information based on correlation between respective query key types.

20. The method of claim 11, wherein the principal characteristic information is any one of an operating system, a version of the operating system, a daemon program and a version list.
